(19) United States
(12) Patent Application Publication
(10) Pub. No.: US 2021/0065014 A1
(43) Pub. Date: Mar. 4, 2021

(54) SUBJECT DISCRIMINATING DEVICE, SUBJECT DISCRIMINATING METHOD, AND NON-TRANSITORY COMPUTER-READABLE MEDIUM

(71) Applicant: NIHON KOHDEN CORPORATION, Tokyo (JP)

(72) Inventors: Yoshifumi SUMIOKA, Tokorozawa-shi (JP); Tsutomu KAWANO, Tokorozawa-shi (JP); Keiichi SATOH, Tokorozawa-shi (JP)

(21) Appl. No.: 16/996,971

(22) Filed: Aug. 19, 2020

(30) Foreign Application Priority Data
Aug. 29, 2019 (JP) 2019-156733

(51) Int. Cl. G06N 3/08; G06N 3/04

(52) U.S. Cl. CPC G06N 3/088; G06N 3/0454

(57) ABSTRACT

A subject discriminating device method: acquiring a first data set corresponding to change of physiological information and a second data set corresponding to change of the physiological information acquired at a different timing; generating a discriminator having learned one of the first data set and the second data set as training data; calculating a degree of similarity using input information for a data set which is the first data set or the second data set and has not been used to generate the discriminator and first output information which is obtained by inputting the data set which is not used to generate the discriminator to the discriminator; determining whether the first data set and the second data set have been acquired from a same subject based on the degree of similarity; and outputting an output signal corresponding to a result of determination.

### CROSS-REFERENCE TO RELATED APPLICATIONS

This application is based on and claims priority under 35 USC 119 from Japanese Patent Application No. 2019-156733 filed on Aug. 29, 2019, the contents of which are incorporated herein by reference.

### TECHNICAL FIELD

The presently disclosed subject matter relates to a device and method for discriminating subjects of electrocardiography or the like, a computer program for making the device perform the method, and a computer-readable medium retaining the computer program.

### BACKGROUND

As an examination for measuring the electrical activity of a heart, there is electrocardiography using an electrocardiograph. In the case of conducting electrocardiography, the user inputs subject information such as a subject ID before starting measurement of electrocardiogram. Physiological information such as electrocardiogram data is recorded in association with the input subject information (see Japanese Patent Application Laid-Open No. H07-155300 (hereinafter, referred to as Patent Literature 1)).

However, in the electrocardiograph disclosed in Patent Literature 1, it is feared that in the case where there is any error in the input subject information, the acquired physiological information may be associated with any other subject. If the acquired physiological information is recorded in association with any other subject, the accuracy of the examination is impaired.

By the way, this problem is not a problem limited to electrocardiogram, and is a problem which may occur even when handling other parameters.

An object of the presently disclosed subject matter is to improve the accuracy related to association between acquired physiological information and subjects.

### SUMMARY

A subject discriminating device of a first aspect of the presently disclosed subject matter includes: an acquiring unit configured to acquire a first data set corresponding to change of physiological information of a subject over time and a second data set corresponding to change of the physiological information of the subject over time, the second data set being acquired at a timing different from an acquisition timing of the first data set; a generator configured to generate a discriminator having learned one of the first data set and the second data set as training data; a determining unit configured to calculate a first degree of similarity using input information for a data set which is the first data set or the second data set and has not been used to generate the discriminator and first output information which is obtained by inputting the data set which is not used to generate the discriminator to the discriminator, and configured to determine whether the first data set and the second data set have been acquired from a same subject based on the first degree of similarity; and an output unit configured to output an output signal corresponding to a result of determination of the determining unit.

A subject discriminating method which is performed by a subject discriminating device and relates to a second aspect of presently disclosed subject matter includes: acquiring a first data set corresponding to change of physiological information of a subject over time and a second data set corresponding to change of the physiological information of the subject over time, the second data set being acquired at a timing different from an acquisition timing of the first data set; generating a discriminator having learned one of the first data set and the second data set as training data; calculating a first degree of similarity using input information for a data set which is the first data set or the second data set and has not been used to generate the discriminator and first output information which is obtained by inputting the data set which is not used to generate the discriminator to the discriminator; and determining whether the first data set and the second data set have been acquired from a same subject based on the first degree of similarity.

A computer-readable non-transitory medium stores a program for causing a computer to execute a process and relates to a third aspect of presently disclosed subject matter. The process includes: acquiring a first data set corresponding to change of physiological information of a subject over time and a second data set corresponding to change of the physiological information of the subject over time, the second data set being acquired at a timing different from an acquisition timing of the first data set; generating a discriminator having learned one of the first data set and the second data set as training data; calculating a first degree of similarity using input information for a data set which is the first data set or the second data set and has not been used to generate the discriminator and first output information which is obtained by inputting the data set which is not used to generate the discriminator to the discriminator; and determining whether the first data set and the second data set have been acquired from a same subject based on the first degree of similarity.

According to the above-described configuration, physiological information acquired from a subject is input to a discriminator having learned the feature of physiological information which may have been acquired from the corresponding subject at a timing different from the acquisition timing of a first data set, and on the basis of the degree of similarity between them, whether they have been acquired from the same subject is determined.

Therefore, it is possible to improve the accuracy related to association between acquired physiological information and subjects.

### BRIEF DESCRIPTION OF DRAWINGS

FIG. 1 illustrates the functional configuration of a subject discriminating device according to an embodiment;

FIG. 2 illustrates the flow of processing which is performed by the subject discriminating device;

FIG. 3 illustrates an example of processing which the subject discriminating device performs until a discriminator is generated;

FIG. 4 illustrates processing which the subject discriminating device performs when performing subject discrimination;

FIG. 5 illustrates the processing which the subject discriminating device performs when performing subject discrimination;

FIG. 6 illustrates the processing which the subject discriminating device performs when performing subject discrimination;

FIG. 7 illustrates data augmentation processing; and

FIG. 8 illustrates another example of the processing which the subject discriminating device performs until the discriminator is generated.

### DESCRIPTION OF EMBODIMENTS

Hereinafter, examples of embodiments will be described in detail with reference to the accompanying drawings.

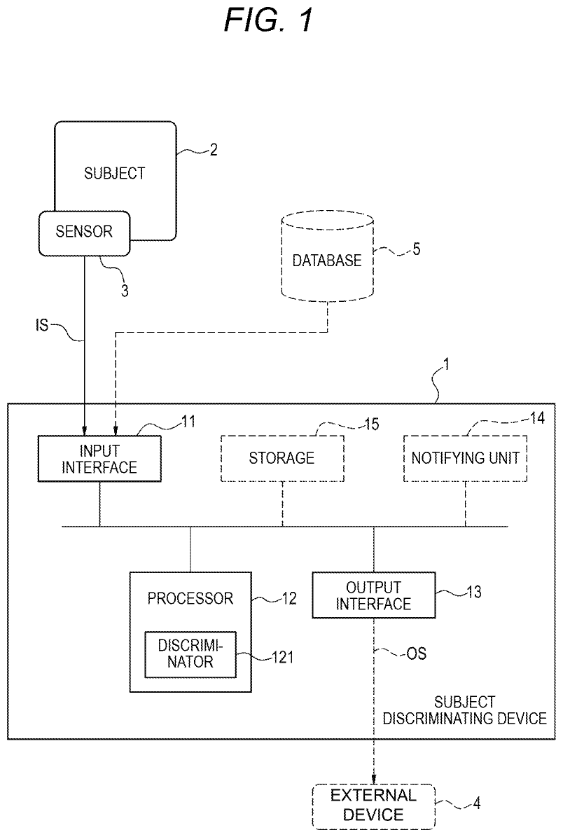

FIG. 1 illustrates the functional configuration of a subject discriminating device 1 (hereinafter, referred to simply as the discriminating device 1) according to one embodiment. The discriminating device 1 includes an input interface 11, a processor 12, and an output interface 13.

The input interface 11 receives an input signal IS corresponding to change of physiological information of a subject 2 over time from a sensor 3 mounted on the body of the subject 2. In the following description, the case where the subject 2 is subjected to electrocardiography is taken as an example. By the way, as information which the sensor 3 acquires, besides electrocardiogram, for example, arterial blood oxygen saturation (SpO2) and so on can be considered.

As the sensor 3, a plurality of electrodes is mounted on the body of the subject 2. The input signal IS represents change of potential over time which is detected by the electrodes. The input interface 11 may include a circuit for converting the input signal IS into a data format on which the processor can perform processing to be described below, if necessary.

The processor 12 is configured to acquire a first data set D1 and a second data set D2. The first data set D includes electrocardiogram waveform information of the subject 2. The electrocardiogram waveform information is an example of data corresponding to change of physiological information over time. The second data set D2 includes electrocardiogram waveform information acquired earlier than the first data set D1. The second data set D2 is an example of a data set including physiological information acquired at a timing different from the acquisition timing of the first data set D1. The processor 12 is an example of an acquiring unit.

The processor 12 is configured to determine whether the first data set D1 and the second data set D2 are data sets acquired from the same subject. Details of the determining process will be described below. The processor 12 is an example of a determining unit.

The processor 12 is configured to output output data corresponding to the determination result. The output interface 13 is configured to output an output signal OS corresponding to the output data. The output signal OS may be transmitted to an external device 4. The output interface 13 may include a circuit for converting output data to an output signal OS which a corresponding external device can process, if necessary. The output interface 13 is an example of an output unit.

The external device 4 may be configured to notify the determination result to the user. The notification may be performed as at least one of visual notification, auditory notification, and tactual notification.

The discriminating device 1 may include a notifying unit 14. In this case, the processor 12 may transmit the output signal OS corresponding to the determination result to the notifying unit 14. In this case, the processor 12 is an example of the output unit. The notifying unit 14 may be configured to notify the determination result to the user, on the basis of the output signal OS. The notification may be performed as at least one of visual notification, auditory notification, and tactual notification.

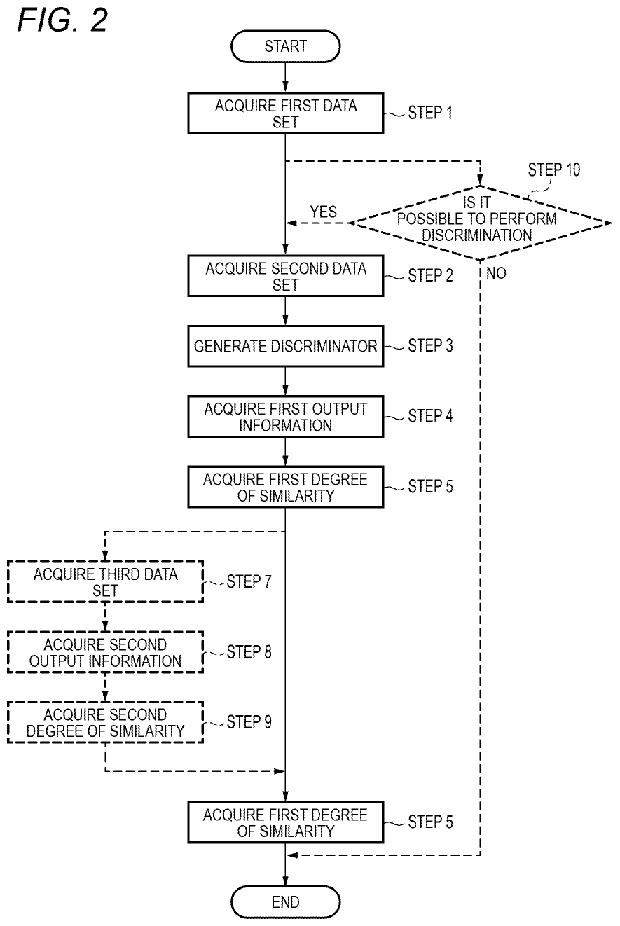

FIG. 2 illustrates the flow of processing which is performed by the processor 12. First, the processor 12 acquires a first data set D1 on the basis of an input signal IS (STEP 1).

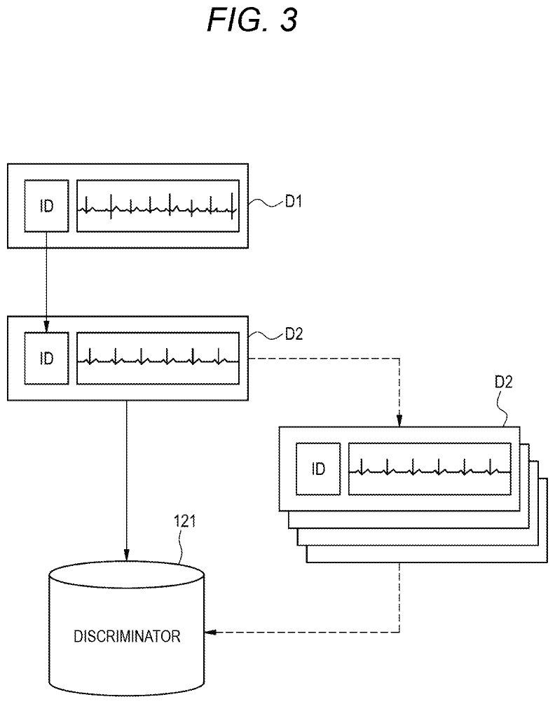

Subsequently, the processor 12 acquires a second data set D2 (STEP 2). For example, as shown in FIG. 3, the first data set D1 may include an identification information ID of a subject 2. The identification information ID may be given by the discriminating device 1, or may be provided together with the input signal IS from the outside. In this case, the processor 12 acquires a second data set D2 corresponding to a past examination result having the same identification information ID.

As shown in FIG. 1, the second data set D2 may be acquired from an external database 5. The processor 12 specifies a data set having the same identification information ID as that of the first data set D1 from past examination results stored in the database 5, and acquires the corresponding data set as a second data set D2.

Alternatively, the discriminating device 1 may include a storage 15 (an example of a storage unit). The storage 15 is a storage device such as a semiconductor memory or a hard disk device. Past examination results may be stored in the storage 15. In this case, the processor 12 specifies a data set having the same identification information ID as that of the first data set D1 from the past examination results stored in the storage 15, and acquires the corresponding data set as a second data set D2.

Subsequently, the processor 12 generates a discriminator 121 having learned the second data set D2 as training data, as shown in FIG. 3 (STEP 3 of FIG. 2). The processor 12 is an example of a generating unit. The discriminator 121 can be understood as a processing function which is executed by the processor 12. The discriminator 121 is configured by extracting a feature quantity of the second data set D2. Specifically, the discriminator 121 is a processing function generated by integrating features of the second data set D2 through learning using the second data set D2 as training data. For example, to the discriminator 121, a data set different from the data set used as training data (in the present embodiment, the second data set D2) may be input. In the case where the corresponding input data set is a set corresponding to the property of the discriminator 121 (the second data set D2), an output similar to the input of the input data set is obtained. The feature quantity of the second data set D2 is not a quantity which is set in advance by the user, and is extracted through learning using training data by the processor 12.

The discriminator 121 may be generated using an autoencoder using dimensionality reduction on middle layers. For example, autoencoding using dimensionality reduction from 1000 dimensions to 125 dimensions is performed using a convolution autoencoder. As other examples of the autoencoder, an autoencoder, a denoising autoencoder, a sparse autoencoder, a stacked autoencoder, and so on can be taken.

According to this configuration, it is possible to efficiently extract features of training data.

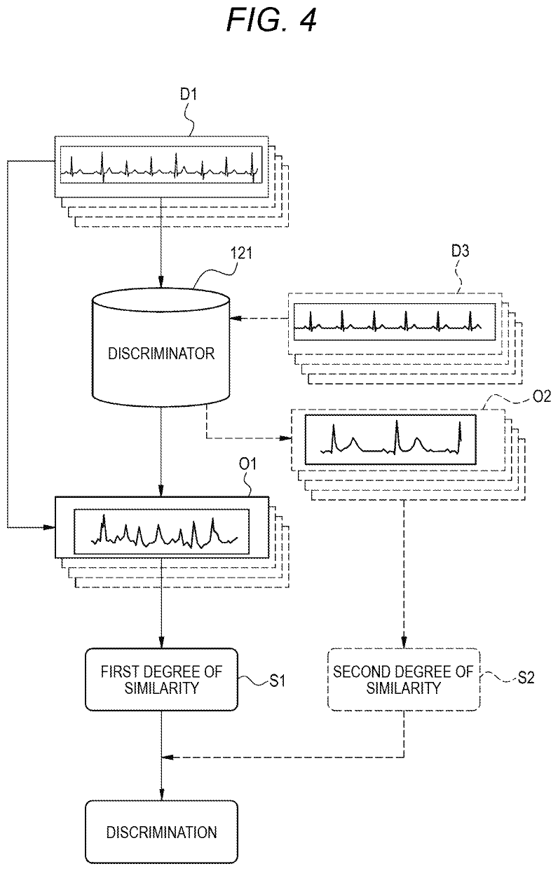

Subsequently, the processor 12 inputs the first data set D1 to the discriminator 121 as shown in FIG. 4. If the first data set D1 is input to the discriminator 121 in which the features of the second data set D2 have been integrated, the processor 12 acquires first output information O1 which is waveform information (STEP 4 of FIG. 2). Here, as the degree of similarity between the features of the first data set D1 and the second data set D2 increases, the degree of similarity between the first output information O1 and the first data set D1 increases.

Subsequently, the processor 12 acquires a first degree of similarity S1 by comparing the first data set D1 and the first output information O1 (STEP 5 of FIG. 2). The first degree of similarity S1 is an index indicating the degree of similarity between the first data set D1 and the first output information O1. For example, the difference between the value of the waveform information included in the first data set D1 and corresponding to a specific time point and the value of the waveform information included in the first output information O1 and corresponding to the corresponding time point is acquired. Such differences acquired with respect to a plurality of time points are statistically processed, whereby the first degree of similarity S1 is acquired.

As statistical processing for acquiring the first degree of similarity S1, for example, root mean squared error may be used. By this statistical processing, the degree of similarity between the first data set D1 and the first output information O1 may be evaluated. By the way, the statistical processing method is not limited to root mean squared error, and may be, for example, mean absolute error (MAE), dynamic time warping (DTW), mean absolute percentage error (MAPE), mean squared error (MSE), cross-correlation function (CCF), or the like.

In the case where the subject 2 which is the source of the first data set D1 is the same as the subject which is the source of the second data set D2, the features included in the waveform information tend to coincide with each other, so the first degree of similarity S which is acquired by comparing the first data set D1 and the first output information O1 becomes high. Meanwhile, in the case where the subject 2 which is the source of the first data set D1 is different from the subject which is the source of the second data set D2, the difference in feature between the first output information O1 in which the feature of the first data set D1 is emphasized and the first data set D1 is emphasized more, whereby the first degree of similarity S1 which is the comparison result becomes low.

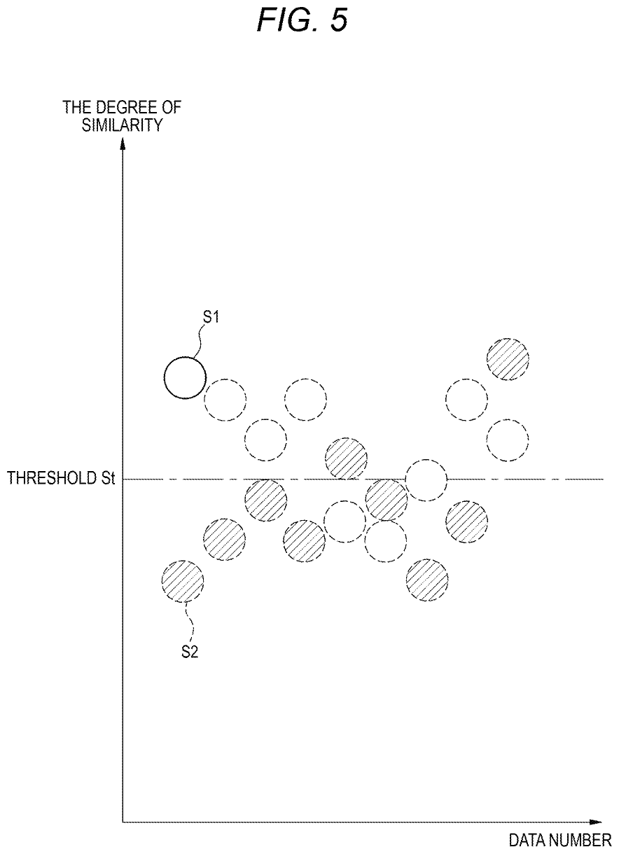

Therefore, the processor 12 can determine whether the first data set D1 and the second data set D2 have been acquired from the same subject, on the basis of the first degree of similarity S1 (STEP 6 of FIG. 2). For example, as shown in FIG. 5, the processor 12 compares the first degree of similarity S1 and a predetermined threshold St. The processor 12 may be configured to determine that the first data set D1 and the second data set D2 have been acquired from the same subject in the case where the first degree of similarity S1 is higher than the threshold St.

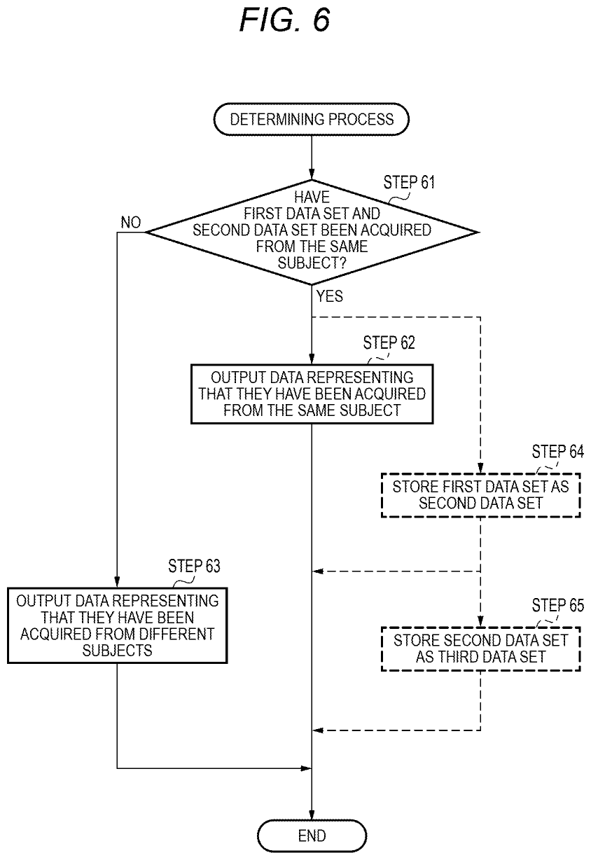

FIG. 6 illustrates details of the flow of the determining process which is performed by the processor 12. If it is determined that the first data set D1 and the second data set D2 have been acquired from the same subject (“YES” in STEP 61), the processor 12 outputs output data representing the corresponding determination result (STEP 62). As a result, an output signal OS based on the corresponding output data is output, and notification of the corresponding determination result is performed by the notifying unit 14 or the external device 4.

If it is determined that the first data set D and the second data set D2 have been acquired from different subjects (“NO” in STEP 61), the processor 12 outputs output data representing the corresponding determination result (STEP 62). As a result, an output signal OS based on the corresponding output data is output, and notification of the corresponding determination result is performed by the notifying unit 14 or the external device 4.

According to this configuration, electrocardiogram waveform information acquired from the subject 2 is input to, for example, the discriminator 121 having learned the feature of electrocardiogram waveform information which may have been acquired from the corresponding subject in the past, and on the basis of the degree of similarity between them, whether they have been acquired from the same subject is determined. In other words, it is possible to support a confirmation that electrocardiogram waveform information associated with the same identification information ID have been acquired from the same subject. Therefore, it is possible to improve the accuracy related to the association between acquired electrocardiogram waveform information and subjects.

As shown in FIG. 2, the processor 12 may further acquire a third data set D3 (see FIG. 4) corresponding to change of physiological information, acquired earlier than the first data set D1 and the second data set, over time (STEP 7 of FIG. 2). By the way, the third data set D3 is an example of a data set including physiological information acquired at a timing different from the acquisition timings of the first data set D1 and the second data set D2. In this case, the processor 12 specifies data sets having the same identification information ID as the identification information ID corresponding to the first data set D1. Then, from the specified data sets, the processor acquires a data set acquired earlier than the second data set, as a third data set D3.

Subsequently, the processor 12 inputs the third data set D3 to the discriminator 121, as shown in FIG. 4. If the third data set D3 is input to the discriminator 121 in which the feature of the second data set D2 has been integrated, the processor 12 acquires second output information O2 which is waveform information (STEP 8 of FIG. 2). Here, as the degree of similarity between the features of the second data set D2 and the third data set D3 increases, the degree of similarity between the second output information O2 and the third data set D3 increases.

Subsequently, the processor 12 compares a second degree of similarity S2 by comparing the third data set D3 and the second output information O2 (STEP 9 of FIG. 2). The second degree of similarity S2 is an index indicating the degree of similarity between the third data set D3 and the second output information O2. For example, the difference between the value of the waveform information included in the third data set D3 and corresponding to a specific time point and the value of the waveform information included in the second output information O2 and corresponding to the corresponding time point is acquired. Such differences acquired with respect to a plurality of time points are statistically processed, whereby the second degree of similarity S2 is acquired.

As statistical processing for acquiring the second degree of similarity S2, root mean squared error may be used. By this statistical processing, the degree of similarity between the third data set D3 and the second output information O2 may be evaluated. By the way, the statistical processing method is not limited to root mean squared error, and may be, for example, mean absolute error (MAE), dynamic time warping (DTW), mean absolute percentage error (MAPE), mean squared error (MSE), cross-correlation function (CCF), or the like.

Subsequently, the processor 12 determines whether the first data set D1 and the second data set D2 have been acquired from the same subject, on the basis of the first degree of similarity S1 and the second degree of similarity S2 (STEP 6 of FIG. 2). For example, as shown in FIG. 5, the processor 12 determines whether the first data set D1 and the second data set D2 have been acquired from the same subject, on the basis of the degree of divergence between the first degree of similarity S1 and the second degree of similarity S2. Specifically, the processor 12 may be configured to determine that the first data set D1 and the second data set D2 have been acquired from the same subject, in the case where the degree of divergence between the first degree of similarity S1 and the second degree of similarity S2 is equal to or smaller than a predetermined value.

According to this configuration, the second degree of similarity S2 is calculated, for example, using the third data set D3 corresponding to change of physiological information, acquired earlier than the second data set D2, over time. Then, the processor 12 determines whether the first data set D1 and the second data set D2 have been acquired from the same subject 2, on the basis of the first degree of similarity S and the second degree of similarity S2. Since it is confirmed that the third data set D3 has been acquired from the subject 2, the third data set has high reliability as data to be used for determination. Therefore, it is possible to improve the accuracy of determination of the processor 12 by using the first degree of similarity S1 and the second degree of similarity S2 calculated from the third data set D3.

The processor 12 may be configured to store the first data set D1 in the storage 15 as a second data set D2 which is a data set usable as training data in the next and subsequent determinations (STEP 64), if it is determined that the first data set D1 and the second data set D2 have been acquired from the same subject (“YES” in STEP 61), as shown in FIG. 6. Alternatively, the second data set D2 may be stored in the database 5.

According to this configuration, if it is confirmed that the first data set D1 has been acquired from the subject 2, the first data set D1 is used as a second data set D2 to be training data for the discriminator 121 in the next and subsequent examinations. In other words, the latest data set acquired from the subject 2 may be used to perform determination on first data sets D1 which are acquired thereafter. Therefore, it is possible to generate discriminators 121 with high accuracy in the next and subsequent examinations. As a result, the accuracy of the result of determination which is performed by the processor 12 improves.

Based on the same reason, the processor 12 may store the second data set D2 in the storage 15, as a third data set D3 which is a data set different from a first data set D1 of data sets to be input to the discriminator 121 (STEP 65). Alternatively, the third data set D3 may be stored in the database 5.

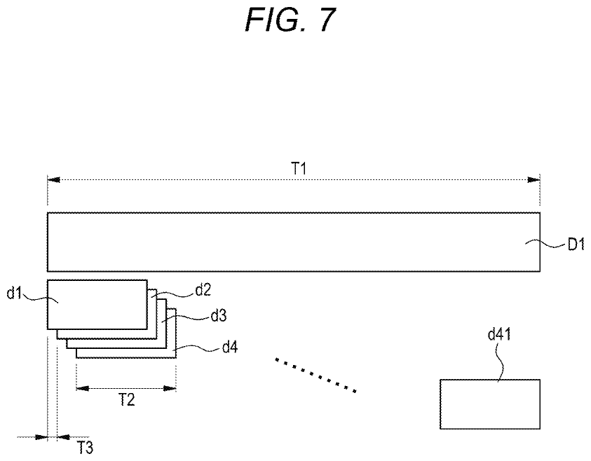

As shown in FIG. 4, augmentation of data may be performed on the first data set D1 by data augmentation. An example of specific methods for data extension will be described with reference to FIG. 7.

In the case where the first data set D1 is physiological information acquired for a time length T1, the processor 12 extracts a data set d1 corresponding to a time length T2 from a time point t1. Subsequently, the processor 12 acquires a data set d2 corresponding to the time length T2 from a time point t2 obtained by adding a time length T3 to the time point t1. In the same way or similarly, the processor 12 acquires a data set d3 corresponding to the time length T2 from a time point t3 obtained by adding the time length T3 to the time point t2.

The time length T1 is, for example, 10 seconds. The time length T2 is, for example, 2 seconds. The time length T3 is, for example, 0.2 seconds. In this case, the data set d1 includes physiological information corresponding to the period from 0 seconds to 2 seconds. The data set d2 includes physiological information corresponding to the period from 0.2 seconds to 2.2 seconds. The data set d3 includes physiological information corresponding to the period from 0.4 seconds to 2.4 seconds.

This processing is repeated, whereby a data set d4 including physiological information corresponding to the period from 8 seconds to 10 seconds is finally acquired, and a total of forty-one data sets d1 to d41 are generated. In the case where the first data set D1 includes 60,000 sampling data, the number of sampling data which each of the data sets d1 to d41 includes is 12,000. Therefore, the number of sampling data which are obtained as results of data augmentation becomes 492,000, and it can be seen that augmentation of data has been performed.

Each of the data sets d1 to d41 generated in the above-mentioned way is input to the discriminator 121. Asa result, as shown in FIG. 4, with respect to the data sets d1 to d41, first output information O1 is acquired, respectively. As the results of comparison between the plurality of first output information O1 and the data sets which are the sources of the first output information, a plurality of first degrees of similarity S1 is calculated, as shown in FIG. 5.

According to this configuration, the processor 12 determines whether the first data set D1 and the second data set D2 have been acquired from the same subject 2, by comparing the plurality of first degrees of similarity S1 with the threshold St. For example, the processor performs determination by comparing the average of the plurality of first degrees of similarity S1 with the threshold St. Since comparison with the threshold St is statistically performed, it is unlikely to be affected by noise. Therefore, the accuracy of the result of determination which is performed by the processor 12 improves.

As shown in FIG. 4, the processor 12 may perform augmentation of data even on the third data set D3 in the same way by data augmentation. In this case, as shown in FIG. 5, a plurality of second degrees of similarity S2 is calculated.

In this case, the processor 12 determines whether the first data set D1 and the second data set D2 have been acquired from the same subject 2, by comparing the plurality of first degrees of similarity S1 and the plurality of second degrees of similarity S2. For example, in the case where the degree of divergence between the average of the plurality of first degrees of similarity S1 and the average of the plurality of second degrees of similarity S2 is lower than a threshold, it is determined that the first data set D1 and the second data set D2 have been acquired from the same subject 2.

According to this configuration, since statistical comparison using the third data set D3 determined as having been acquired from the subject 2 is possible, comparison using the fixed threshold St is unnecessary, and it is possible to perform determination with higher accuracy.

As shown in FIG. 3, the processor 12 may perform augmentation of data on the second data set D2 by data augmentation, and generate a discriminator 121 on the basis of the augmented second data set D2. A specific method of data augmentation is the same as or similar to the method for the first data set D1 and the third data set D3.

According to this configuration, since the number of training data which is used to generate a discriminator 121 is increased by data augmentation, the processor 12 can generate a discriminator 121 with higher accuracy. As a result, the processor 12 can determine whether the first data set D1 and the second data set D2 have been acquired from the same subject 2, with higher accuracy.

As shown in FIG. 2, the processor 12 may determine whether it is possible to perform subject discrimination, on the basis of the acquired first data set D1 (STEP 10 of FIG. 2). To determine whether it is possible to perform discrimination, a well-known noise discrimination program for electrocardiogram, a well-known analysis algorithm for arrhythmia, and so on may be used. For example, in the case where the noise discrimination program for electrocardiogram is used, the processor 12 may determine whether it is possible to perform subject discrimination, by obtaining a noise score by performing statistical processing on the first data set D1 and comparing the noise score with a preset threshold. When the obtained noise score is equal to or larger than the threshold, the processor 12 determines that it is impossible to perform subject discrimination (“NO” in STEP 10), and ends the current processing. In this case, the discriminating device 1 outputs an output signal OS representing that the first data set D1 does not satisfy a predetermined condition required for inputting it to the discriminator 121, from the output interface 13. Meanwhile, if the processor 12 determines that it is possible to perform subject discrimination (“YES” in STEP 10), the processor 12 performs STEP 2 and the subsequent processes.

For example, in the case where there is a large organic change in the heart of the subject, or in the case where the subject has arrhythmia, even if the first data set D1 and the second data set D2 are data sets acquired from the same subject, the feature of the first data set D1, and the feature of the second data set D2 acquired earlier than the first data set D1 may be greatly different. For this reason, the first data set D1 may become noise in performing the above-mentioned statistical processing. According to the above-mentioned configuration, since the first data set D1 which may become noise is not input to the discriminator 121, it is possible to maintain the accuracy of determination.

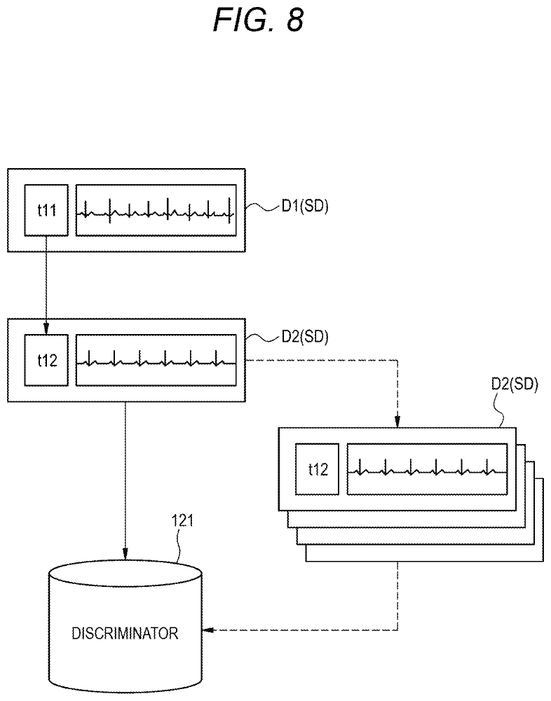

Information which can be used to acquire a second data set D2 is not limited to the identification information ID given to the subject 2. FIG. 8 illustrates the case where the electrocardiogram waveform information of the subject 2 is acquired as streaming data SD. The streaming data SD is stored in the storage 15 of the discriminating device 1 or the database 5. In the present example, the discriminating device 1 is configured such that if interruption occurs in inputting of streaming data SD, the discriminating device acquires streaming data SD acquired before the corresponding interruption. As examples of causes of the interruption of the input, drop of the sensor 3 from the body of the subject 2, a communication failure, and so on can be taken.

As shown in FIG. 8, streaming data SD may include time information indicating the acquisition time point. A time point ti1 indicates the time point of start of acquisition of streaming data SD after recovery from input interruption. In other words, the processor 12 acquires streaming data SD having the time point t11 as time information as a first data set D1 (STEP 1 of FIG. 2).

In the case where interruption has occurred in inputting the streaming data, the processor 12 acquires streaming data SD having a time point t12 before the time point t1 Ias time information, as a second data set D2 (STEP 2 of FIG. 2).

Subsequently, the processor 12 performs the processes of STEP 3 to STEP 6 shown in FIG. 2. In other words, the processor 12 generates a discriminator 121 having learned, as training data, the second data set D2 (the data set acquired before the interruption of the input) which is the streaming data SD having the time point t12 as time information. Subsequently, the processor 12 acquires a first degree of similarity S1 by inputting the first data set D1 (the data set acquired after recovery from the interruption of the input) which is the streaming data SD having the time point t1 as time information to the discriminator 121. Then, the processor 12 determines whether the first data set D1 and the second data set D2 have been acquired from the same subject, by comparing the first degree of similarity S1 and the threshold St.

According to the above-mentioned configuration, the electrocardiogram waveform information acquired from the subject 2 after the interruption of the input of the streaming data is input to the discriminator 121 having learned the feature of the electrocardiogram waveform information which may have been acquired from the corresponding subject 2 in the past, and on the basis of the degree of similarity between them, whether they have been acquired from the same subject is determined. In other words, it is possible to support a confirmation that the electrocardiogram waveform information acquired before and after the interruption of the input of the streaming data have been acquired from the same subject. Therefore, it is possible to improve the accuracy related to the association between acquired electrocardiogram waveform information and subjects.

The processor having the function described above may be implemented with a general-purpose microcomputer which operates in cooperation with a general-purpose memory. The corresponding processor may include a plurality of processor cores. As examples of the general-purpose memory, a ROM, a RAM, and so on can be taken. In the general-purpose memory, a computer program for performing processing to be described below may be stored. The corresponding computer program may be stored in the general-purpose memory in advance, or may be downloaded from an external server through a communication network. The corresponding computer program is an example of a command which the processor can execute. For example, the processor may designate at least a part of a computer program stored in a ROM, and develop the designated part on a RAM, and performs processing to be described below, in cooperation with the RAM.

In the present embodiment, computer-readable media may be used. Computer-readable media indicate every type of physical memories (such as RAMs and ROMs) capable of storing information and data which processors can read. Computer-readable media can store one or more commands related to processing which can be performed by processors. By the way, the term “computer-readable media” includes tangible items, and does not include carrier waves and temporal signals (i.e. it indicates non-transitory items).

However, the presently disclosed subject matter is not limited to the above-described embodiment, and various modifications, improvements, etc. can be made as appropriate. Also, the materials, shapes, dimensions, numeric values, modes, numbers and installation places, and so on of the individual components of the above-described embodiment are optional and are not limited as long as it is possible to implement the presently disclosed subject matter.

In the above-described embodiment, the processor 12 generates the discriminator 121 using the second data set D2 as training data. In other words, the first data set D1 is an example of a data set not used to generate a discriminator (in other words, a data set to be input to the discriminator 121). However, the processor 12 may generate a discriminator 121 using the first data set D1 as training data. In this case, the second data set D2 is an example of a data set not used to generate a discriminator. In other words, in the case of performing determination on the identity of subjects using the first data set D1 and the second data set D2, the processor needs only to generate a discriminator 121 from one data set, regardless of the acquisition timings of the individual data sets (regardless of which data set was acquired first), and input the other data set to the discriminator 121. The determination on the identity of subjects is determination on whether the first data set D1 and the second data set D2 have been acquired from the same subject.

Also, the processor 12 may generate a discriminator 121 using the third data set D3 as training data. In this case, the first data set D1 and the second data set D2 become examples of a data set not used to generate a discriminator (in other words, a data set to be input to the discriminator 121). In other words, in the case of performing determination on the identity of subjects using the first data set D1 to the third data set D3, the processor needs only to generate a discriminator 121 from one arbitrary data set, regardless of the acquisition timings of the individual data sets (regardless of which data set was acquired first), and input the other two data sets to the discriminator 121.

In the above-described embodiment, the second data set D2 is a data set acquired earlier than the first data set D1; however, the first data set D1 may be a data set acquired earlier than the second data set D2. Also, the third data set D3 is a data set acquired earlier than the second data set; however, the third data set D3 may be a data set acquired later than at least one of the first data set D1 and the second data set D2.

What is claimed is:

1. A subject discriminating device comprising:
an acquiring unit configured to acquire a first data set corresponding to change of physiological information of a subject over time and a second data set corresponding to change of the physiological information of the subject over time, the second data set being acquired at a timing different from an acquisition timing of the first data set;
a generator configured to generate a discriminator having learned one of the first data set and the second data set as training data;
a determining unit configured to calculate a first degree of similarity using input information for a data set which is the first data set or the second data set and has not been used to generate the discriminator and first output information which is obtained by inputting the data set which is not used to generate the discriminator to the discriminator, and configured to determine whether the first data set and the second data set have been acquired from a same subject based on the first degree of similarity; and
an output unit configured to output an output signal corresponding to a result of determination of the determining unit.

2. The subject discriminating device according to claim 1, wherein
the acquiring unit is further capable of acquiring a third data set corresponding to change of the physiological information over time, the third data set being acquired at a timing different from acquisition timings of the first data set and the second data set, and
the determining unit is configured to calculate a second degree of similarity using input information on the third data set and second output information which is obtained by inputting the third data set to the discriminator, and is configured to determine whether the first data set and the second data set have been acquired from the same subject based on the first degree of similarity and the second degree of similarity.

3. The subject discriminating device according to claim 1, wherein
the first data set includes identification information of the subject, and
the acquiring unit is configured to acquire the second data set with reference to the identification information of the subject.

4. The subject discriminating device according to claim 1, further comprising:
a storage unit capable of storing data sets,
wherein when the determining unit determines that the first data set and the second data set have been acquired from the same subject, the data set which is not used to generate the discriminator is stored in the storage unit so as to be usable as the training data.

5. The subject discriminating device according to claim 1, wherein
the first data set and the second data set are streaming data.

6. The subject discriminating device according to claim 1, wherein
augmentation of data is performed on the data set to be used to generate the discriminator by data augmentation.

7. The subject discriminating device according to claim 1, wherein
when the data set which is not used to generate the discriminator does not satisfy a predetermined condition for inputting it to the discriminator, the output unit outputs an output signal representing that the data set does not satisfy the predetermined condition.

8. The subject discriminating device according to claim 1, wherein
the determining unit is configured to calculate the first degree of similarity by root mean squared error.

9. The subject discriminating device according to claim 2, wherein
the determining unit is configured to calculate the first degree of similarity and the second degree of similarity by root mean squared error.

10. The subject discriminating device according to claim 1, wherein
the discriminator is generated using an autoencoder.

11. A subject discriminating method which is performed by a subject discriminating device, comprising:
acquiring a first data set corresponding to change of physiological information of a subject over time and a second data set corresponding to change of the physiological information of the subject over time, the second data set being acquired at a timing different from an acquisition timing of the first data set;
generating a discriminator having learned one of the first data set and the second data set as training data;
calculating a first degree of similarity using input information for a data set which is the first data set or the second data set and has not been used to generate the discriminator and first output information which is obtained by inputting the data set which is not used to generate the discriminator to the discriminator; and
determining whether the first data set and the second data set have been acquired from a same subject based on the first degree of similarity.

12. A computer-readable non-transitory medium storing a program for causing a computer to execute a process, the process comprising:
acquiring a first data set corresponding to change of physiological information of a subject over time and a second data set corresponding to change of the physiological information of the subject over time, the second data set being acquired at a timing different from an acquisition timing of the first data set;
generating a discriminator having learned one of the first data set and the second data set as training data;
calculating a first degree of similarity using input information for a data set which is the first data set or the second data set and has not been used to generate the discriminator and first output information which is obtained by inputting the data set which is not used to generate the discriminator to the discriminator; and
determining whether the first data set and the second data set have been acquired from a same subject based on the first degree of similarity.
